(19) United States
(12) Patent Application Publication
(10) Pub. No.: US 2006/0292488 A1
(43) Pub. Date: Dec. 28, 2006

(54) Composition for formation of antireflection film, and antireflection film in which the same is used

(75) Inventors: Toshikazu Takayama, Kanagawa (JP); Yasushi Fujii, Kanagawa (JP); Hisanobu Harada, Kanagawa (JP); Koji Yonemura, Kanagawa (JP); Isamu Takagi, Kanagawa (JP); Daisuke Kawana, Kanagawa (JP); Kazufumi Sato, Kanagawa (JP)

Correspondence Address: HARNESS, DICKEY & PIERCE, P.L.C., P.O. BOX 828, BLOOMFIELD HILLS, MI, 48303, US

(73) Assignee: Tokyo Ohka Kogyo Co., Ltd., Kanagawa (JP)

(21) Appl. No.: 11/446,763

(22) Filed: Jun. 5, 2006

(30) Foreign Application Priority Data
Jun. 7, 2005 (JP) 2005-167042

(51) Int. Cl. C08G 77/26; G03C 1/00

(52) U.S. Cl. 430/270.1; 528/38

(57) ABSTRACT

A composition for formation of an antireflection film having an excellent etching resistant characteristic and ability to prevent reflection of short-wavelength light (absorption ability of short-wavelength light) as well as excellent time dependent stability, and an antireflection film in which the same is used, are provided. A composition for formation of an antireflection film including a siloxane compound having a light-absorbing group and a crosslinking group, the siloxane compound being blocked with a capping group, is provided. By thus blocking the siloxane compound with a capping group, time dependent stability can be improved without deteriorating etching resistance, and ability to prevent reflection.

This application is based on and claims the benefit of priority from Japanese Patent Application No. 2005-167042, filed on 7 Jun. 2005, the content of which is incorporated herein by reference.

### BACKGROUND OF THE INVENTION

1. Field of the Invention

The present invention relates to a composition for formation of an antireflection film which is used for microfabrication in manufacturing steps of integrated circuit elements and the like, and a pattern formation method using the same. More particularly, the present invention relates to a composition for formation of an antireflection film that is suitable for forming a pattern through exposing light having a wavelength of 300 nm or less, and an antireflection film in which the same is used.

2. Related Art

In manufacturing integrated circuit elements, there has been progress in miniaturization of processing size in lithography processes with a view to obtaining integrated circuits with a high degree of integration. In these lithography processes, a resist pattern is formed by coating a photoresist composition on a workpiece layer, followed by exposure and development, and the resist pattern thus formed is transferred to a workpiece film such as a wiring layer, a dielectric layer or the like.

Conventionally, an exposed region of the workpiece film, being the region exposed in the resist pattern, was removed by dry etching. However, film thickness of the resist layer (i.e., the resist pattern) was decreased by shortening the wavelength of the light source for exposure or the like, accompanying miniaturization of the processing size. Therefore, sufficient dry etching resistance cannot be acquired, thereby making the processing of the workpiece film with high accuracy difficult to achieve. Also, due to a problem of reflection of the exposed light on the workpiece film, it is difficult to form a resist pattern in a favorable shape.

Hence, for transferring a resist pattern to a workpiece film with good accuracy, insertion of an antireflection film (hard mask) between the workpiece film and the photo resist layer has been studied. As a characteristic of this antireflection film the etching rate is required to have a large difference from that of the resist pattern (see, for example, Japanese Patent Application, Laid Open Nos. 2004-310019, 2005-015779, and 2005-018054).

However, antireflection film material in each document described above exhibit inferior, time dependent stability. Thus, when they are left to stand for a long period of time, they may be unusable due to change in the molecular weight and the like causing gelation. Even if not gelled, it is difficult to achieve desired characteristics, due to the change in the molecular weight and the like, thereby causing change from the initial stage, in various characteristics such as coating properties.

### SUMMARY OF THE INVENTION

The present invention was made in view of the foregoing problems, and an object of the invention is to provide a composition for formation of an antireflection film with favorable etching resistant characteristics and ability to prevent reflection of short-wavelength light (absorption ability of short-wavelength light) as well as excellent time dependent stability, and an antireflection film in which the same is used.

In order to solve the aforementioned problems, the present invention includes a composition for formation of an antireflection film including a siloxane compound having a light-absorbing group and a crosslinking group, wherein the siloxane compound is characterized in that it is blocked with a capping group. Use of this siloxane compound enables improvement in time dependent stability of the composition for formation of an antireflection film.

Furthermore, examples of the terminal blocking group which may be used include groups having 1 to 6 carbon atoms, and preferably trialkylsilyl groups. Accordingly, the amount of carbon in the siloxane compound that increases due to the light-absorbing group and the crosslinking group, can be adjusted. Therefore, etching selectivity, for the resist layer, of the antireflection film, which is formed with this composition for formation of an antireflection film, can be controlled. In other words, the etching rate of the antireflection film can be adjusted with regard to the etching rate of the resist layer, and the etching rate of the workpiece film or the lower layer formed on the workpiece film. Therefore, by using the composition for formation of an antireflection film of the present invention, an antireflection film having an optimum etching rate can be formed.

Use of the composition for formation of an antireflection film in the present invention enables formation of a pattern with high dimensional accuracy.

### DETAILED DESCRIPTION OF THE INVENTION

The composition for formation of an antireflection film of the present invention includes a siloxane compound having a light-absorbing group and a crosslinking group, the siloxane compound being blocked with a capping group.

The siloxane compound in the present invention has a light-absorbing group and a crosslinking group, and is blocked with a capping group.

The light-absorbing group herein may be a group having absorption a wavelength range of 150 to 300 nm. Examples of this light-absorbing group include groups having a light-absorbing part, such as a benzene ring, an anthracene ring, a naphthalene ring or the like. The light-absorbing part is preferably bound to a Si atom of the main skeleton via an alkylene group having 1 to 20 carbon atoms which may be interrupted by one or more —O—, or —O(CO)—. Also, the light-absorbing part such as a benzene ring, an anthracene ring, or a naphthalene ring may be substituted with one or more substituents such as an alkyl group having 1 to 6 carbon atoms, a hydroxy group, or the like. Among these light-absorbing groups, a benzene ring is preferred.

Moreover, the crosslinking group described below may be bound to the light-absorbing part.

The aforementioned crosslinking group refers to a group capable of reacting with other crosslinking group, or capable of reacting with a crosslinking agent otherwise added. Examples of the crosslinking group include a hydrosilyl group, or crosslinkable organic groups. This crosslinking group preferably forms crosslinkage upon heating, and examples thereof include organic groups having an ethylenic double bond, organic groups having an epoxy group, and organic groups having an oxetanyl group. These organic groups having an ethylenic double bond, groups having an epoxy group and/or an oxetanyl group are preferably bound to a Si atom via an alkylene group having 1 to 20 carbon atoms which may be interrupted by one or more —O—, or —O(CO)—. It is most preferable that the crosslinking group has an oxetanyl group on the ground of the storage stability.

Use of the siloxane compound to which such a crosslinking group is introduced enables formation of a stable antireflection film by baking at a low temperature such as 150 to 350° C., preferably 150 to 250° C.

The aforementioned capping group is a group substituted with a reactive group remaining in a precursor siloxane compound. Examples of this capping group include alkyl groups, alkylcarbonyloxy groups, acetoxy groups, cycloalkyl groups, trialkylsilyl groups, and the like. Among these, the capping groups having all carbon atoms of 1 to 6 are preferred, and those having 1 to 3 carbon atoms are even more preferred. A specific example of a preferable capping group is a trimethylsilyl group. By including a group having 1 to 6 carbon atoms, and preferably a group having 1 to 3 carbon atoms as described above, adjustment of the amount of carbon in the entire siloxane compound can be readily conducted.

The precursor siloxane compound is generally obtained by hydrolysis and condensation of a silicon-containing compound having a hydrolyzable group. When produced, a reactive group (for example, an alkoxy group, a hydroxyl group or the like bound to the silicon atom) which had not completely reacted in the aforementioned hydrolysis and condensation reaction may remain at the end of the precursor siloxane compound. By forming a siloxane-compound through substituting this reactive group with the aforementioned capping group, time dependent stability of the composition for formation of an antireflection film can be improved.

More particularly, the siloxane compound according to the invention may be represented as a siloxane compound (A) having a constitutional unit represented by the following general formulas (1), (2) and (3):

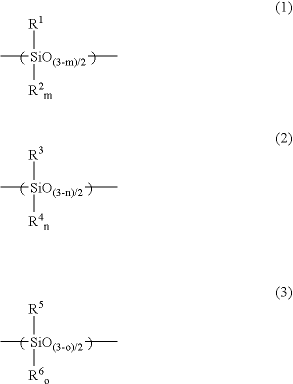

wherein, R¹ represents a light-absorbing group; R³ represents a crosslinking group; R⁵ represents a capping group; R², R⁴, and R⁶ each represent a hydrogen atom, a hydroxy group, or an alkyl group having 1 to 3 carbon atoms; and m, n, o each represent 0 or 1.

When m, n, and o are 0, the siloxane compound is silsesquioxane, which is a polymer having a silicone ladder structure. When m, n, and o are 1, the siloxane compound is a straight silicone polymer. In cases of a siloxane compound other than these, the siloxane compound will be the corresponding copolymer thereof. Particularly, silicone ladder type siloxane compounds are preferred in terms of time dependent stability of the composition for formation of an antireflection film.

The capping group can be introduced by treating the precursor siloxane compound including the aforementioned constitutional units (1) and (2) with, for example, a silylation agent.

The precursor siloxane compound including the constitutional units (1) and (2) can be obtained by hydrolysis and condensation of a mixture of the following silicon-containing compounds (1′) and (2′): 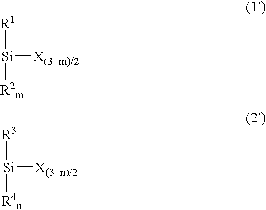
wherein, R¹, R², R³, R⁴, m, and n are as defined above; X represents a halogen group, hydroxy group, or an alkoxy group having 1 to 5 carbon atoms; when X is present in a plural number, X may be the same or different.

With respect to the amount of water in the hydrolysis reaction, it is preferred that 0.2 to 10 mol per mol of the monomer be added. In this process, a catalyst can be also used. Examples of the catalyst include acids such as acetic acid, propionic acid, oleic acid, stearic acid, linoleic acid, salicylic acid, benzoic acid, formic acid, malonic acid, phthalic acid, fumaric acid, citric acid, tartaric acid, hydrochloric acid, sulfuric acid, nitric acid, sulfonic acid, methylsulfonic acid, tosylic acid, and trifluoromethanesulfonic acid; bases such as ammonia, sodium hydroxide, potassium hydroxide, barium hydroxide, calcium hydroxide, trimethylamine, triethylamine, triethanolamine, tetramethylammonium hydroxide, choline hydroxide, and tetrabutylammonium hydroxide; metal chelate compounds such as tetraalkoxytitanium, trialkoxymono(acetylacetonate)titanium, tetraalkoxyzirconium, and trialkoxymono(acetylacetonate)zirconium. Moreover, when an oxetanyl group, an epoxy group or the like is included as the crosslinking group, it is preferred that system environment with a pH of 7 or greater be provided so as not to permit ring opening. Thus, an alkaline agent such as ammonia, a quaternary ammonium salt, an organic amine or the like is preferably used. In particular, tetraalkylammonium hydroxide is preferably used in terms of favorable activity as a base catalyst, and ease in controlling the reaction.

Furthermore, by treating the precursor siloxane compound with a silylation agent, R⁵ being a capping group can be introduced, thereby enabling production of the siloxane compound (A).

Example of the silylation agent include trimethylmethoxysilane, hexamethyldisilazane, tetramethyldibutyldisilazane, hexaethyldisilazane, tetramethyldivinyldisilazane, tetravinyldimethyldisilazane, N-trimethylsilylacetamide, N,O-bis(trimethylsilyl)acetamide, N-trimethylsilylimidazole, and the like. Preferably, the silylation agent is hexaalkyldisilazane, and is particularly preferably hexamethyldisilazane.

The capping group is preferably introduced to the reactive group in the precursor siloxane compound in an amount of approximately 100%.

In the aforementioned siloxane compound (A), the constituent unit (1) is preferably 0.01 to 99 mol %, more preferably 0.1 to 70 mol %, and even more preferably 0.15 to 30 mol %. By having the range described above, the light absorption characteristic can be improved. Particularly, when an ArF laser, i.e., a wavelength of 193 nm is employed in exposure of the resist film, it is necessary to arrange so that the antireflection film can be formed having an optical parameter (k value) for the light with this wavelength falling within the range of 0.002 to 0.95, preferably 0.01 to 0.7, and more preferably 0.05 to 0.25. This arrangement can be made by varying the proportion of the included constituent unit (1).

Also, in the siloxane compound (A), the constituent unit (2) accounts for preferably 0.01 to 99 mol %, more preferably 0.1 to 70 mol %, and even more preferably 0.15 to 30 mol %. By having the range described above, hardening properties of the formed antireflection film can be improved, thereby minimizing mixing with the upper layer and cracking.

Additionally, in the aforementioned siloxane compound (A), the constituent unit (3) accounts for preferably 0.01 to 99 mol %, more preferably 0.1 to 70 mol %, and even more preferably 0.5 to 30 mol %. Introduction of this constituent unit (3) allows storage stability to be improved.

In the present invention, the siloxane compound most preferably consists of only the three constituent units (1), (2), and (3).

Furthermore, in the siloxane compound, it is preferred that the carbon number per SiO unit be predetermined as 0 to 6, and preferably 1 to 4.

The weight average molecular weight of the siloxane compound (based on conversion into polystyrene on gel permeation chromatography) is not particularly limited, but is preferably 200 to 10000, and more preferably 500 to 5000.

Examples of preferable siloxane compound include those represented by the following formula (A1).

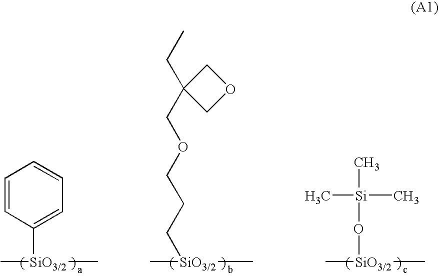

The composition for formation of an antireflection film of the present invention preferably contains a solvent (B). Examples of this solvent include: monohydric alcohols such as methyl alcohol, ethyl alcohol, propyl alcohol, and butyl alcohol; polyhydric alcohols such as ethylene glycol, diethylene glycol, propylene glycol, glycerol, trimethylolpropane, and hexanetriol; monoethers of a polyhydric alcohol such as ethylene glycol monomethyl ether, ethylene glycol monoethyl ether, ethylene glycol monopropyl ether, ethylene glycol monobutyl ether, diethylene glycol monomethyl ether, diethylene glycol monoethyl ether, diethylene glycol monopropyl ether, diethylene glycol monobutyl ether, propylene glycol monomethyl ether, propylene glycol monoethyl ether, propylene glycol monopropyl ether, and propylene glycol monobutyl ether; esters such as methyl acetate, ethyl acetate, butyl acetate, and ethyl lactate; ketones such as acetone, methyl ethyl ketone, cycloalkyl ketone, and methyl isoamyl ketone; polyhydric alcohol ethers obtained by alkyl etherification of all hydroxyl groups of a polyhydric alcohol such as ethylene glycol dimethyl ether, ethylene glycol diethyl ether, ethylene glycol dipropyl ether, ethylene glycol dibutyl ether, propylene glycol dimethyl ether (PGDM), propylene glycol diethyl ether, propylene glycol dibutyl ether, diethylene glycol dimethyl ether, diethylene glycol methylethyl ether, and diethylene glycol diethyl ether; and the like. Among these, cycloalkyl ketone or alkylene glycol dialkyl ether is more suitable. Moreover, PGDM (propylene glycol dimethyl ether) is suitable as the alkylene glycol dimethyl ether. These organic solvents may be used alone, or in combination of two or more thereof. This solvent is preferably used at the rate of 1 to 50 times, preferably 2 to 20 times the amount of the siloxane compound (A).

To the composition for formation of an antireflection film of the present invention may be added a crosslinking catalyst generator (C) for accelerating the crosslinking reaction.

As this crosslinking catalyst generator (C), an acid generator which generates an acid upon exposure to heat or light, or a base generator which generates a base upon exposure to heat or light can be used.

Examples of an available thermal acid generator which generates an acid upon exposure to heat include commonly used thermal acid generators involving 2,4,4,6-tetrabromocyclohexadienone, benzoin tosilate, 2-nitrobenzyl tosilate, other alkyl esters of organic sulfonic acid, and compositions containing at least one of the foregoing thermal acid generators.

Examples of an available photosensitive acid generator which generates an acid upon exposure to light include known acid generators such as onium salts, diazomethane derivatives, glyoxime derivatives, bissulfone derivatives, β-ketosulfone derivatives, disulfone derivatives, nitrobenzyl sulfonate derivatives, sulfonic acid ester derivatives, sulfonic acid ester derivatives of an N-hydroxyimide compound, and the like.

Specific examples of the onium salt include tetramethylammonium trifluoromethanesulfonate, tetramethylammonium nonafluorobutanesulfonate, tetra n-butylammonium nonafluorobutanesulfonate, tetraphenylammonium nonafluorobutanesulfonate, tetramethylammonium p-toluenesulfonate, diphenyliodonium trifluoromethanesulfonate, (p-tert-butoxyphenyl)phenyliodonium trifluoromethanesulfonate, diphenyliodonium p-toluenesulfonate, (p-tert-butoxyphenyl)phenyliodonium p-toluenesulfonate, triphenylsulfonium trifluoromethanesulfonate, (p-tert-butoxyphenyl)diphenylsulfonium trifluoromethanesulfonate, bis(p-tert-butoxyphenyl)phenylsulfonium trifluoromethanesulfonate, tris(p-tert-butoxyphenyl)sulfonium trifluoromethanesulfonate, triphenylsulfonium p-toluenesulfonate, (p-tert-butoxyphenyl)diphenylsulfonium p-toluenesulfonate, bis(p-tert-butoxyphenyl)phenylsulfonium p-toluenesulfonate, tris(p-tert-butoxyphenyl)sulfonium p-toluenesulfonate, triphenylsulfonium nonafluorobutanesulfonate, triphenylsulfonium butanesulfonate, trimethylsulfonium trifluoromethanesulfonate, trimethylsulfonium p-toluenesulfonate, cyclohexylmethyl(2-oxocyclohexyl)sulfonium trifluoromethanesulfonate, cyclohexylmethyl(2-oxocyclohexyl)sulfonium p-toluenesulfonate, dimethylphenylsulfonium trifluoromethanesulfonate, dimethylphenylsulfonium p-toluenesulfonate, dicyclohexylphenylsulfonium trifluoromethanesulfonate, dicyclohexylphenylsulfonium p-toluenesulfonate, trinaphthylsulfonium trifluoromethanesulfonate, cyclohexylmethyl(2-oxocyclohexyl)sulfonium trifluoromethanesulfonate, (2-norbonyl)methyl(2-oxocyclohexyl)sulfonium trifluoromethanesulfonate, ethylenebis[methyl(2-oxocyclopentyl)sulfonium trifluoromethanesulfonate], 1,2′-naphthylcarbonylmethyltetrahydrothiophenium triflate, and the like.

Examples of the diazomethane derivative include bis(benzenesulfonyl)diazomethane, bis(p-toluenesulfonyl)diazomethane, bis(xylenesulfonyl)diazomethane, bis(cyclohexylsulfonyl)diazomethane, bis(cyclopentylsulfonyl)diazomethane, bis(n-butylsulfonyl)diazomethane, bis(isobutylsulfonyl)diazomethane, bis(sec-butylsulfonyl)diazomethane, bis(n-propylsulfonyl)diazomethane, bis(isopropylsulfonyl)diazomethane, bis(tert-butylsulfonyl)diazomethane, bis(n-amylsulfonyl)diazomethane, bis(isoamylsulfonyl)diazomethane, bis(sec-amylsulfonyl)diazomethane, bis(tert-amylsulfonyl)diazomethane, 1-cyclohexylsulfonyl-1-(tert-butylsulfonyl)diazomethane, 1-cyclohexylsulfonyl-1-(tert-amylsulfonyl)diazomethane, 1-tert-amylsulfonyl-1-(tert-butylsulfonyl)diazomethane, and the like.

Examples of the glyoxime derivative include bis-O-(p-toluenesulfonyl)-α-dimethylglyoxime, bis-O-(p-toluenesulfonyl)-α-diphenylglyoxime, bis-O-(p-toluenesulfonyl)-α-dicyclohexylglyoxime, bis-O-(p-toluenesulfonyl)-2,3-pentanedioneglyoxime, bis-O-(p-toluenesulfonyl)-2-methyl-3,4-pentanedioneglyoxime, bis-O-(n-butanesulfonyl)-α-dimethylglyoxime, bis-O-(n-butanesulfonyl)-α-diphenylglyoxime, bis-O-(n-(butanesulfonyl)-α-dicyclohexylglyoxime, bis-O-(n-butanesulfonyl)-2,3-pentanedioneglyoxime, bis-O-(n-butanesulfonyl)-2-methyl-3,4-pentanedioneglyoxime, bis-O-(methanesulfonyl)-α-dimethylglyoxime, bis-O-(trifluoromethanesulfonyl)-α-dimethylglyoxime, bis-O-(1,1,1-trifluoroethanesulfonyl)-α-dimethylglyoxime, bis-O-(tert-butanesulfonyl)-α-dimethylglyoxime, bis-O-(perfluorooctanesulfonyl)-α-dimethylglyoxime, bis-O-(cyclohexanesulfonyl)-α-dimethylglyoxime, bis-O-(benzenesulfonyl)-α-dimethylglyoxime, bis-O-(p-fluorobenzenesulfonyl)-α-dimethylglyoxime, bis-O-(p-tert-butylbenzenesulfonyl)-α-dimethylglyoxime, bis-O-(xylenesulfonyl)-α-dimethylglyoxime, bis-O-(camphorsulfonyl)-α-dimethylglyoxime, and the like.

Examples of the aforementioned bissulfone derivative include bisnaphthylsulfonylmethane, bistrifluoromethylsulfonylmethane, bismethylsulfonylmethane, bisethylsulfonylmethane, bispropylsulfonylmethane, bisisopropylsulfonylmethane, bis-p-toluenesulfonylmethane, bisbenzenesulfonylmethane, and the like.

Examples of the aforementioned β-ketosulfone derivative include 2-cyclohexylcarbonyl-2-(p-toluenesulfonyl)propane, 2-isopropylcarbonyl-2-(p-toluenesulfonyl)propane, and the like.

Examples of the disulfone derivative include disulfone derivatives such as diphenyldisulfone derivatives, dicyclohexyldisulfone derivative, and the like.

Examples of the aforementioned nitrobenzylsulfonate derivative include nitrobenzylsulfonate derivatives such as 2,6-dinitrobenzyl p-toluenesulfonate, 2,4-dinitrobenzyl p-toluenesulfonate, and the like.

Examples of the aforementioned sulfonic acid ester derivative include sulfonic acid ester derivatives such as 1,2,3-tris(methanesulfonyloxy)benzene, 1,2,3-tris(trifluoromethanesulfonyloxy)benzene, 1,2,3-tris(p-toluenesulfonyloxy)benzene, and the like.

Examples of the aforementioned sulfonic acid ester derivative of an N-hydroxyimide compound include N-hydroxysuccinimide methanesulfonate ester, N-hydroxysuccinimide trifluoromethanesulfonate ester, N-hydroxysuccinimide ethanesulfonate ester, N-hydroxysuccinimide 1-propanesulfonate ester, N-hydroxysuccinimide 2-propanesulfonate ester, N-hydroxysuccinimide 1-pentanesulfonate ester, N-hydroxysuccinimide 1-octanesulfonate ester, N-hydroxysuccinimide p-toluenesulfonate ester, N-hydroxysuccinimide p-methoxybenzenesulfonate ester, N-hydroxysuccinimide 2-chloroethanesulfonate ester, N-hydroxysuccinimide benzenesulfonate ester, N-hydroxysuccinimide 2,4,6-trimethylbenzenesulfonate ester, N-hydroxysuccinimide 1-naphthalenesulfonate ester, N-hydroxysuccinimide 2-naphthalenesulfonate ester, N-hydroxy-2-phenylsuccinimide methanesulfonate ester, N-hydroxymaleimide methanesulfonate ester, N-hydroxymaleimide ethanesulfonate ester, N-hydroxy-2-phenylmaleimide methanesulfonate ester, N-hydroxyglutarimide methanesulfonate ester, N-hydroxyglutarimide benzenesulfonate ester, N-hydroxyphthalimide methanesulfonate ester, N-hydroxyphthalimide benzenesulfonate ester, N-hydroxyphthalimide trifluoromethanesulfonate ester, N-hydroxyphthalimide p-toluenesulfonate ester, N-hydroxynaphthalimide methanesulfonate ester, N-hydroxynaphthalimide benzenesulfonate ester, N-hydroxy-5-norbornene-2,3-dicarboxyimide methanesulfonate ester, N-hydroxy-5-norbornene-2,3-dicarboxyimide trifluoromethanesulfonate ester, N-hydroxy-5-norbornene-2,3-dicarboxyimide p-toluenesulfonate ester, and the like.

Furthermore, examples of an available thermal base generator which generates a base upon exposure to heat include carbamate derivatives such as 1-methyl-1-(4-biphenylyl)ethylcarbamate, and 1,1-dimethyl-2-cyanoethylcarbamate; urea derivatives such as urea, and N,N-dimethyl-N′-methylurea; dihydropyridine derivatives such as 1,4-dihydronicotinamide; quaternary ammonium salts of organic silane or organic borane; dicyanogendiamide; and the like. In addition, other examples include guanidine trichloroacetate, methylguanidine trichloroacetate, potassium trichloroacetate, guanidine phenylsulfonylacetate, guanidine p-chlorophenylsulfonylacetate, guanidine p-methanesulfonylphenylsulfonylacetate, potassium phenylpropiolate, guanidine phenylpropiolate, cesium phenylpropiolate, guanidine p-chlorophenylpropiolate, guanidine p-phenylene-bis-phenylpropiolate, tetramethylammonium phenylsulfonylacetate, tetramethylammonium phenylpropiolate, and the like.

Moreover, examples of the photosensitive base generator which generates a base upon exposure to light include triphenylmethanol, photoactive carbamate such as benzylcarbamate and benzoincarbamate; amide such as O-carbamoylhydroxylamide, O-carbamoyloxime, aromatic sulfoneamide, alpha-lactam and N-(2-allylethynyl)amide, and other amide; oxime esters, α-aminoacetophenone, cobalt complexes, and the like. Among these, preferable examples include 2-nitrobenzylcyclohexylcarbamate, triphenylmethanol, o-carbamoylhydroxylamide, o-carbamoyloxime, [[(2,6-dinitrobenzyl)oxy]carbonyl]cyclohexylamine, bis[[(2-nitrobenzyl)oxy]carbonyl]hexane 1,6-diamine, 4-(methylthiobenzoyl)-1-methyl-1-morpholinoethane, (4-morpholinobenzoyl)-1-benzyl-1-dimethylaminopropane, N-(2-nitrobenzyloxycarbonyl)pyrrolidine, hexaaminecobalt(III)tris(triphenylmethylborate), 2-benzyl-2-dimethylamino-1-(4-morpholinophenyl)-butanone, and the like.

Among all, it is preferred that a thermal acid generator be used as the crosslinking catalyst generator (C).

Particularly preferable examples among these include onium salts having a decomposition point of 250° C. or less, such as triphenylsulfonium trifluoromethanesulfonate, triphenylsulfonium nonafluorobutanesulfonate, a 7,7-dimethyl-bicyclo-[2,2,1]-heptane-2-one-1-sulfonic acid salt of bis(p-t-butylphenyl)iodonium, and the like.

The aforementioned crosslinking catalyst generator (C) may be used alone, or two or more thereof can be used in combination.

The amount of the crosslinking catalyst generator (C) added is preferably 0.1 to 50 parts by weight, more preferably 0.5 to 40 parts by weight per 100 parts by weight of the siloxane compound having the constituent units represented by the general formulas (1), (2) and (3). By adding in an amount of 0.1 parts by weight or more, a sufficient effect to accelerate the crosslinking reaction can be realized. Moreover, by adding an amount of 50 parts by weight or less, transfer of the acid to the resist layer formed on the antireflection film can be suppressed, thereby preventing the phenomenon of mixing.

A crosslinking agent (D) for accelerating the crosslinking reaction, and for improving hardening properties of the antireflection film, may be added to the composition for formation of an antireflection film of the present invention.

Examples of this crosslinking agent include epoxy compounds such as bisphenol A epoxy resin, bisphenol F epoxy resin, bisphenol S epoxy resin, phenol novolak epoxy resin, and cresol novolak epoxy resin; compounds having two or more reactive groups such as divinylbenzene, divinylsulfone, triacryl formal, glyoxal and acrylic acid esters or methacrylic acid esters of a polyhydric alcohol, and compounds obtained by substitution of at least two amino groups of melamine, urea, benzoguanamine or glycoluril with a methylol group or a lower alkoxy methyl group; and the like.

The aforementioned crosslinking agent can be used alone, or in a combination of two or more.

The added amount of addition of the crosslinking agent is preferably 0.1 to 50 parts by weight, and more preferably 0.5 to 40 parts by weight per 100 parts by weight of the siloxane compound having the constituent units represented by the general formulas (1), (2) and (3). By adding an amount of 0.1 parts by weight or more, an effect sufficient to accelerate the crosslinking reaction can be realized. Moreover, by adding an amount of 50 parts by weight or less, the crosslinking reaction can be further accelerated, and thus, the hardening property of the antireflection film can be further improved.

Pattern Formation Method

A pattern formation method in which the composition for formation of an antireflection film of the present invention is used will be explained. This pattern formation method is a method for forming a pattern on a workpiece film such as a substrate or the like by lithography.

The present pattern formation method has at least the following steps (1) to (4):

(1) coating the composition for formation of an antireflection film of the present invention on a workpiece film, and baking to form an antireflection film;

(2) coating a photoresist composition on an antireflection film, and prebaking to form a photoresist film;

(3) exposing a pattern circuit region of the photoresist film, followed by developing with a liquid developer to form a resist pattern; and

(4) etching the antireflection film and a substrate using the resist pattern as a mask to form a pattern on the workpiece film.

In the pattern formation method described above, a pattern was formed on a workpiece film by etching an antireflection film and a workpiece film using a resist pattern as a mask; however, a pattern can be also formed on a workpiece film by etching an antireflection film using a resist pattern as a mask, and further etching a workpiece film using as a mask the antireflection film on which the pattern was formed.

Moreover, it is preferred that a lower layer film (bottom layer) be formed between the workpiece film and the antireflection film described above. Examples of the method for forming a pattern on the workpiece film in this instance include: (i) a method in which a pattern is formed on a workpiece film by etching an antireflection film, a lower layer film and the workpiece film using a resist pattern as a mask; (ii) a method in which a pattern is formed on a workpiece film by etching an antireflection film using a resist pattern as a mask, and further etching a lower layer film and the workpiece film using as a mask the antireflection film on which the pattern was formed; (iii) a method in which a pattern is formed on a workpiece film by etching an antireflection film using a resist pattern as a mask, and further etching a lower layer film and the workpiece film using as a mask the antireflection film on which the pattern was formed; (iv) a method in which etching an antireflection film and a lower layer film using a resist pattern as a mask is followed by further using as a mask the lower layer film on which the pattern was formed to form a pattern on a workpiece film; and the like.

Herein, the lower layer film may be a resin such as cresol novolak, naphthol novolak, katol dicyclopentadiene novolak, amorphous carbon, polyhydroxystyrene, acrylate, methacrylate, polyimide, polysulfone or the like.

The antireflection film requires adjustment of etching rate in accordance with the etching rate of the upper layer and/or the lower layer as described above.

The composition for formation of an antireflection film of the present invention may be used in applications in which patterning of a workpiece film is performed using a resist pattern, an antireflection film and a lower layer film. In particular, the aforementioned method (ii) in which a pattern is formed on a workpiece film by etching an antireflection film using a resist pattern as a mask, and further etching a lower layer film and the workpiece film using as a mask the antireflection film on which the pattern was formed is preferably used.

For forming this antireflection film, the composition for formation of an antireflection film may be spin-coated on the workpiece film or the lower layer film, dried, and thereafter heated. Heating may be conducted by a process with single heating or multiple heating steps. When the process with multiple heating steps is employed, the heating can be conducted, for example, at 100 to 120° C. for 60 to 120 sec, and then at 200 to 250° C. for 60 to 120 sec. Accordingly, after forming the antireflection film having, for example a thickness of 30 to 200 nm, a resist film may be produced thereon with a resist material to give a thickness of 100 to 300 nm by a common procedure. The lower layer film may be formed on the workpiece film similarly to the antireflection film to give, for example, a thickness of 200 to 600 nm.

The composition for formation of an antireflection film of the present invention can be readily coated on a base material such as a silicon wafer using a commonly employed spin coating process, thereby enabling the antireflection film having a desired thickness to be formed. Taking into account the necessity of forming an oxidized film on a base material by vapor deposition, and providing a resist film thereon in conventional resist processes, significant simplification is possible.

The resist composition for use in forming the resist layer may be any known one, and for example, a combination of a base resin, an organic solvent and an acid generator can be used.

Examples of the base resin include one or more macromolecular polymers selected from a group consisting of: polyhydroxystyrene and derivatives thereof; polyacrylic acid and derivatives thereof; polymethacrylic acid and derivatives thereof; copolymers formed through selecting from hydroxystyrene, and acrylic acid and methacrylic acid, and derivatives thereof; copolymers of three or more selected from cycloolefin and derivatives thereof, and maleic anhydride and acrylic acid, and derivatives thereof; copolymers of three or more selected from cycloolefin and derivatives thereof, maleimide and acrylic acid, and derivatives thereof; polynorbornene, and ring-opening metathesis polymers. The derivatives herein refer to those with a main skeleton remaining after the derivation so as to include acrylate ester or the like in acrylic acid derivatives, methacrylate ester or the like in methacrylic acid derivatives, alkoxystyrene or the like in hydroxystyrene derivatives.

Examples for resists for KrF excimer laser include copolymers formed through selecting from polyhydroxystyrene (PHS), hydroxystyrene, and styrene, acrylic acid ester, methacrylic acid ester, and maleimide N-carboxylic acid ester; while examples for resists for ArF excimer laser include those of acrylic ester-based, methacrylic ester-based, alternating copolymerization system of norbornene and maleic anhydride, alternating copolymerization system of tetracyclododecene and maleic anhydride, polynorbornene-based, and metathesis polymerization system by ring-opening polymerization, but are not limited to these polymers of the polymerization system.

### EXAMPLES

Hereinafter, the present invention will be explained in more detail by way of Examples; however the present invention is not limited by these Examples.

### Example 1

A precursor siloxane compound was obtained by hydrolysis and condensation of the monomers (1a) and (2a) represented by the following formulas.

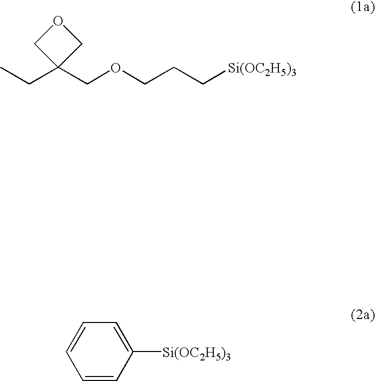

By treating the resulting precursor siloxane compound with hexamethyldisilazane, a siloxane compound represented by the above formula (A1) was obtained. This siloxane compound was a compound represented by the above formula (A1) (molecular weight Mw: 900, a:b:c=18:57:25).

Preparation of Composition for Formation of Antireflection Film

A composition for forming a hard mask (composition for formation of an antireflection film) was prepared using 100 parts by weight of this siloxane compound, 3000 parts by weight of a mixed solvent of propylene glycol monomethyl ether acetate and ethyl lactate (6:4) as a solvent (B), and 5 parts by weight of Epikote 157S70 (manufactured by Japan Epoxy Resins Co., Ltd.) as a crosslinking agent (D).

Pattern Formation

On a silicon wafer having a SiO₂ layer with a thickness of 500 nm on its top face a composition was coated to form a lower layer film containing a novolak resin using a conventionally employed resist coater, and heat treatment was carried out under conditions of 250° C. for 90 sec to form a bottom layer having a thickness of 220 nm.

Next, the prepared composition for forming a hard mask was coated on the bottom layer, and heat treatment was carried out under conditions of 250° C. for 90 sec to form a hard mask having a thickness of 30 nm. This antireflection film had a k value of 0.18, and an n value of 1.74.

Furthermore, a resist composition was coated on the antireflection film to form a resist layer, and a line pattern with 120 nm space/240 nm pitch was formed by exposure with an ArF excimer laser through the mask, followed by development.

The resist composition used in the above procedure was prepared by mixing each of the following components:

resin: 100% by weight of a resin having a unit (D1:D2:D3=4:4:2, molecular weight 10000) represented by the following formulas:

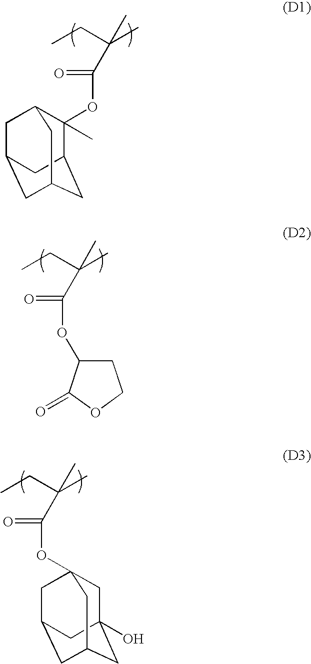

acid generator: 1) 2.0% by weight of a compound represented by the following formula:

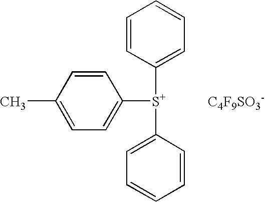

2) 0.8% by weight of a compound represented by the following formula:

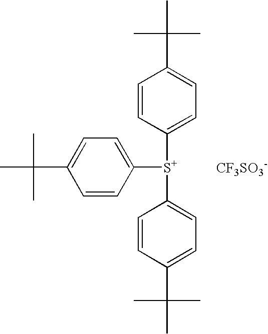

acid quencher: 1) 0.25% by weight of triethanolamine

2) 25.0% by weight of γ-butyrolactone solvent: propylene glycol monomethyl ether acetate:propylene glycol monomethyl ether=6:4.

First, etching of the antireflection film was carried out using the aforementioned line pattern as a mask.

The etching was carried out under the following conditions, and film thickness of the line pattern following the etching was measured to determine etching selectivity of the line pattern and the antireflection film.

Chamber pressure: 3 mm Torr

RF power: 1600 W

Bias: 70 W

Temperature: −10° C.

Etching gas: SF₃/Ar=10/100

Film thickness of the line pattern following the etching was 116 nm. Etching selectivity of the line pattern and the antireflection film was 1/1.2.

Subsequently, etching of the bottom layer was carried out using the hard mask as a mask.

The etching was carried out under the following conditions, and film thickness of the hard mask following the etching was measured to determine etching selectivity of the antireflection film and the bottom layer.

Chamber pressure: 3 mm Torr

RF power: 1600 W

Bias: 70 W

Temperature: −10° C.

Etching gas: O₂/N₂=60/40

Film thickness of the hard mask following the etching was 20 nm. Etching selectivity of the hard mask and the bottom layer was 1/15.

Subsequently, etching of the SiO₂ layer was carried out using the bottom layer as a mask.

The etching was carried out under the following conditions, and film thickness of the SiO₂ layer following the etching was measured to determine etching selectivity of the bottom layer and the SiO₂ layer.

Chamber pressure: 3 mm Torr

RF power: 1600 W

Bias: 150 W

Temperature: 20° C.

Etching gas: C₄F₈/CH₂F₂/O₂/Ar=7/33/2/100

Film thickness of the SiO₂ layer following the etching was 30 nm. Etching selectivity of the bottom layer and the SiO₂ layer was 1/7.8.

Time Dependent Stability

With respect to time dependent stability of the composition for forming a hard mask, a 10% by weight PGMEA solution of the siloxane compound (A1) was prepared, and left to stand at 40° C. for 48 hrs. Alteration of the molecular weight was determined on GPC (gel permeation chromatography). As a result, the molecular weight was 2690 before leaving to stand, and was 2530 after leaving to stand. Rate of change of the molecular weight was 6%, suggesting almost no alteration. Accordingly, excellent time dependent stability was demonstrated.

### Comparative Example 1

Evaluation of time dependent stability was made using a precursor siloxane compound which had not been treated with hexamethyldisilazane in the aforementioned Example 1. As a result, the molecular weight was 850 before leaving to stand, and was 1200 after leaving to stand. Rate of change of the molecular weight was 42%, suggesting bad time dependent stability.

From the foregoing, when a composition for forming a hard mask was prepared using a precursor siloxane compound as in Comparative Example 1, it is clear that time dependent stability is inferior, and keeping the characteristics found in the initial stage of preparation is difficult.

While preferred embodiments of the present invention have been described and illustrated above, it is to be understood that they are exemplary of the invention and are not to be considered to be limiting. Additions, omissions, substitutions, and other modifications can be made thereto without departing from the spirit or scope of the present invention. Accordingly, the invention is not to be considered to be limited by the foregoing description and is only limited by the scope of the appended claims.

What is claimed is:

1. A composition for formation of an antireflection film comprising a siloxane compound having a light-absorbing group and a crosslinking group,
wherein said siloxane compound is blocked with a capping group.

2. A composition for formation of an antireflection film according to claim 1 wherein said capping group is a group having 1 to 6 carbon atoms.

3. A composition for formation of an antireflection film according to claim 1 wherein said capping group is a trialkylsilyl group.

4. A composition for formation of an antireflection film according to claim 3 wherein said capping group is a trimethylsilyl group.

5. A composition for formation of an antireflection film according to claim 1 wherein said light-absorbing group is selected from groups having a benzene ring, an anthracene ring, or a naphthalene ring.

6. A composition for formation of an antireflection film according to claim 1 wherein said crosslinking group is an organic group having an epoxy group, or an organic group having an oxetanyl group.

7. A composition for formation of an antireflection film according to claim 6, wherein said crosslinking group is an organic group having an oxetanyl group.

8. A composition for formation of an antireflection film according to claim 1 further comprising an acid generator.

9. A composition for formation of an antireflection film according to claim 1, further comprising a crosslinking agent.

10. A composition for formation of an antireflection film according to claim 1 wherein an antireflection film having an optical parameter (k value) for an ArF laser falling within a range of 0.002 to 0.95 can be formed.

11. An antireflection film obtained by coating a composition for formation of an antireflection film according to any one of claim 1 to 10, followed by baking.
